(19) United States
(12) Patent Application Publication
(10) Pub. No.: US 2013/0043195 A1
(43) Pub. Date: Feb. 21, 2013

(54) WATER RECLAMATION SYSTEMS AND METHODS

(71) Applicants: Michael T. O'Konek, South Haven, MN (US); Dusten C. O'Konek, JR., Annandale, MN (US); Dusten C. O'Konek, SR., South Haven, MN (US)

(72) Inventors: Michael T. O'Konek, South Haven, MN (US); Dusten C. O'Konek, JR., Annandale, MN (US); Dusten C. O'Konek, SR., South Haven, MN (US)

(73) Assignee: O3 INDUSTRIES, LLC, St. Cloud, MN (US)

(21) Appl. No.: 13/588,459

(22) Filed: Aug. 17, 2012

Related U.S. Application Data
(60) Provisional application No. 61/525,042, filed on Aug. 18, 2011.

(51) Int. Cl. C02F 9/04; B04B 9/06; B04B 7/02; C02F 1/38; C02F 9/02

(52) U.S. Cl. 210/749; 210/241; 210/198.1; 210/188; 210/787; 494/60

(57) ABSTRACT

A mobile water recovery system and methods of recycling water from slurry produced by pavement grinding machines. The system includes a platform having a plurality of wheels, a slurry storage tank or a slurry settling tank, a centrifuge in flow communication with the slurry storage tank or slurry settling tank, such as a hydraulic centrifuge, a solids storage component, and a cleaned water storage tank in flow communication with the centrifuge. The system may also include an acidifier which may be located within the cleaned water storage tank. The acidifier may bubble engine exhaust through the cleaned water or may dispense a pH adjusting agent into the clean water storage tank.

### PRIORITY

This application claims priority to U.S. Provisional Patent Application No. 61/525,042, filed Aug. 18, 2011 and entitled Water Reclamation System, the disclosure of which is hereby incorporated by reference.

### BACKGROUND

Pavement grinders are used for grinding paved surfaces such as roadways. Such grinding may be done to prepare the surface for resurfacing or to texture the surface to improve traction or water drainage. During the grinding process, water is typically sprayed directly onto the grinder blades for cooling and lubrication. A slurry is formed which includes chunks of pavement of various sizes as well as particles of pavement suspended in the water. The grinders suck up the slurry and transfer it to a tanker at an off-site plant or into a holding pond for transportation and later treatment. In some cases, depending upon local laws, the slurry is pumped directly into a roadside ditch. In this way, pavement grinders consume large quantities of water. While the grinders have water tanks which are filled at the start of operations, because so much water is used, these tanks are not sufficient to allow the grinders to operate continuously without periodically being refilled by a tanker truck that travels to the worksite to refill the grinders' water tanks

In addition to periodic tanker trips to the worksite to refill water tanks, the tanker that holds the slurry must also periodically unload the slurry. Systems for separating the water from the particulate components are known, but such systems have various drawbacks and are not ideal for mobile use.

In addition, due to the composition of concrete pavement, which may include portland cement, sand, fly ash, and various aggregates, the slurry is typically highly basic. Exhaust pollution deposited on the road surface also contributes to the composition of the slurry and makes it more basic. As such, it is preferable not to dispose of the slurry, or the water contained in the slurry, into the environment without adjusting the pH, and in some regions pH adjustment is legally required.

### SUMMARY

Embodiments include mobile water recovery systems for recovering water from pavement slurry. The system can include a platform having a plurality of wheels, a slurry storage tank, a centrifuge in flow communication with the slurry storage tank, a solids storage component, and a cleaned water storage tank in flow communication with the centrifuge. In some embodiments, the system also includes a sieve and the slurry first passes through the sieve and then passes into the centrifuge. In some embodiments, the system may use a slurry settling tank in place of the slurry storage tank and sieve. In some embodiments, the system also includes an acidifier, which can be located within the cleaned water storage tank.

In some embodiments, the acidifier is located in a cleaned water storage tank and acidifies the recovered water by bubbling engine exhaust through the cleaned water.

In some embodiments, the centrifuge is a hydraulic centrifuge.

In other embodiments, the mobile water recovery system includes a platform having a plurality of wheels, a slurry storage tank, a centrifuge in flow communication with the slurry storage tank, a solids storage component, a cleaned water storage tank in flow communication with the centrifuge, an engine which produces exhaust, and an exhaust bubbler within the cleaned water storage tank. The exhaust bubbler can be configured to receive the exhaust from the engine and release the exhaust through a plurality of apertures in the exhaust bubbler when the cleaned water storage tank contains cleaned water. The bubbles produced by the exhaust bubbler can be sufficient to reduce the pH of the cleaned water to less than about 10, for example.

In some embodiments, the exhaust bubbler includes an exhaust inlet and a bubbler plate which is a horizontally oriented with the plurality of apertures located on the upper surface of the plate.

In some embodiments, the system also includes a blower located in exhaust flow communication between an exhaust outlet of the engine and the exhaust bubbler. The system may also include an exhaust cleaning unit in flow communication between the engine exhaust outlet and the exhaust bubbler to reduce the amount of hydrocarbons in the exhaust.

Other embodiments include methods of recycling water from slurry produced by pavement grinders. The method may include the steps of pumping the slurry into a slurry storage tank, centrifuging the slurry to separate a solid component from a cleaned water component, transmitting the cleaned water component from the centrifuge to a cleaned water tank, and transmitting the solid component to a solids storage component. The slurry storage tank, the centrifuge, the cleaned water tank, and the solids storage component can each be components of a mobile water reclamation system, and the method can further include towing the mobile reclamation system behind a pavement grinder.

In some embodiments, the method also includes reducing the pH of the cleaned water within the cleaned water tank. For example, the water reclamation system may also include an engine which produces exhaust, and reducing the pH of the cleaned water may include bubbling the exhaust through the cleaned water. In some embodiments, the method also includes reducing the amount of hydrocarbons present in the exhaust prior to bubbling the exhaust through the cleaned water.

In some embodiments, the method includes passing the slurry through a sieve prior to centrifuging the slurry.

Still other embodiments of the invention include a system for acidifying a fluid including an engine which produces exhaust including carbon dioxide, a fluid tank, and an exhaust bubbler having a plurality of apertures and located within the fluid tank. Exhaust produced by the engine can flow to the exhaust bubbler and through the apertures. In some embodiments, the system also includes an exhaust treatment unit designed to remove organics and particulates from the exhaust. The exhaust flows through the exhaust treatment unit prior to flowing through the bubbler. The system can further include a blower, such that the exhaust flows through the blower prior to flowing through the exhaust bubbler.

Still other embodiments include centrifugation systems including a housing having an inlet and a first outlet, a rotatable bowl within the housing in flow communication with the inlet and the outlet, and a hydraulic pump. The rotatable bowl may rotate around a central axis which may be vertical. The hydraulic pump powers rotation of the rotatable bowl and may be a hydrostatic pump. The hydraulic pump may be controlled by a variable DC signal, for example. The centrifugation system may further include a second outlet, and the first outlet may remove liquids while the second outlet may remove solids from the centrifuge.

### FIGURES

FIG. 1 is a side view of a water reclamation system according to an embodiment of the invention;

FIG. 2 is a top view of the water reclamation system of FIG. 1 according to an embodiment of the invention;

FIG. 3 is a top view of an exhaust bubbler system according to an embodiment of the invention;

FIG. 4 is a side view of the exhaust bubbler system of FIG. 3 according to an embodiment of the invention;

FIG. 5 is an end view of the exhaust bubbler system of FIGS. 3 and 4 according to an embodiment of the invention; and

FIG. 6 is a schematic flow chart of a system according to an embodiment of the invention.

### DESCRIPTION

The following detailed description is exemplary in nature and is not intended to limit the scope, applicability, or configuration of the invention in any way. Rather, the following description provides some practical illustrations for implementing examples of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

Embodiments of the invention include methods and systems for recovery of water used by pavement grinding machines. The systems may be mobile, and may be provided as a trailer for attachment directly to a pavement grinding machine or other vehicle, or may be self propelled. In some embodiments, the methods and systems further include neutralization of the recovered water using vehicle emissions, such as by bubbling engine exhaust through the recovered water.

Pavement grinders use a large quantity of water to cool the cutting tools as they grind the pavement. As such, after a pavement grinder passes over a piece of pavement, such as a road, parking lot, or runway, the water is sprayed directly onto the pavement and/or the cutting tools from one or more spray nozzles on the pavement grinder. The pavement grinder then removes the slurry from the roadway or other surface. This slurry is then passed to a water recovery system according to embodiments of the invention.

Embodiments of the invention process the slurry to separate the water from the solid components. The slurry passes through the water recovery system, which may include a slurry storage tank, a slurry strainer, one or more centrifuges, a dry material storage compartment, and a clean water storage tank. The clean water that is produced may then be returned to the pavement grinding machine for use in further pavement grinding operations, or may be released into the environment. In some embodiments, the clean water may be further processed to cool the water and/or to neutralize the pH by acidifying the water, such as by bubbling engine exhaust through the cleaned water.

In some embodiments, the water recovery system may be in the form of a wheeled system, such as a trailer, which may attach to the back of a pavement grinder. In such systems, one or more hoses and cables may connect the grinder to the water recovery system which trails it or otherwise travels adjacent to it, so that water recovery, purification, and recycling of cleaned water to the grinder, occurs simultaneously with pavement grinding. Alternatively, the water recovery system may be pulled by a different vehicle or may be self propelled and may or may not be connected to the pavement grinder.

The slurry that is produced by pavement grinders includes water with fine particulates which are ground pieces of pavement and can also include pavement chunks and road debris. The pavement grinders typically include a hose and pump to recover the slurry from the ground surface and pump it either onto the roadside or into a storage tank. When the pavement grinder is used with the water recovery system according to embodiments of the invention, the slurry may be pumped directly from the ground and into a slurry storage tank in the water recovery system or from the grinder slurry storage tank into the water recovery system slurry storage tank. This transfer may occur under the control of the hoses and pumps that are typically part of pavement grinders. The slurry storage tank of the water recovery system includes an inlet for receipt of slurry from the pavement grinder and an outlet. The storage tank may be any water tight heavy duty compartment. It may hold about 1,000 to about 1,500 gallons of slurry, for example, or other amounts depending upon engineering design choices. It may include an agitator to keep the particulates in suspension, such as a paddle or pumps, located within the tank, to recirculate the water in the tank to keep particulates in suspension.

In some embodiments, the water reclamation system includes two strainers and two centrifuges, with separate portions of the slurry passing in parallel through the first strainer to the first centrifuge and through the second strainer to the second centrifuge. In still other embodiments, the water reclamation system may include a third strainer and a third centrifuge, with slurry passing likewise in parallel to the third strainer and third centrifuge. Alternatively, the slurry may pass through one or more strainers in series and may then pass to a first, second and/or third centrifuge in parallel. For example, the strainers in series, such as two or three strainers, may be sized to separate different sized items, such as increasingly smaller items. Thus it will be understood that the system may include a plurality of strainers and centrifuges. Solid material separated out of the slurry by the strainers may be periodically removed manually or may be periodically expelled by the strainers.

In some embodiments, the slurry may next pass through pipes to an optional slurry strainer. This strainer may be in the form of a sieve, for example. The strainer may be used to remove large roadway debris from the slurry, such as fallen vehicles pieces (such as bolts, hubcaps, tire scraps), garbage (such as beverage containers or plastic bags), or other roadway debris. The strainer may also remove large pieces of pavement that may be present in the slurry. For example, in some embodiments, the strainer may be sized to exclude items measuring about 1/16 inch or larger, or about ⅛ inch or larger, while in other embodiments it may be sized to exclude items measuring about ¼ inch or about ½ inch or larger.

In some embodiments, the slurry may enter into a slurry settling tank which may be used in addition to, or in place of, the slurry storage tank. For example, the water reclamation system may include a slurry settling tank in place of the slurry storage tank and the slurry strainer, and slurry may pass directly from the grinder to the slurry settling tank and then to the centrifuge. The slurry settling tank may be in the form of a vertically mounted conical or cylindrical tank which may have a greater height than width. The slurry settling tank may include a debris removal element for removing debris, such as an auger or pump, with may be connected to the bottom of the tank for removing debris from the bottom of the settling tank. The settling tank may be used to remove large roadway debris from the slurry, such as fallen vehicles pieces (such as bolt, hubcaps, tire scraps), garbage (such as beverage containers or plastic bags), or other roadway debris or large pieces of pavement that may be present in the slurry. For example, in some embodiments, the flow through the settling tank may be adjusted to exclude items measuring about 1/16 inch or larger, or about ⅛ inch or larger, while in other embodiments it may be adjusted to exclude items measuring about ¼ inch or about ½ inch or larger.

In some embodiments, slurry is transmitted into the slurry settling tank through an inlet which may be at a midlevel of depth within the tank, while the outlet may be located above the inlet, such as near the top of the tank. As slurry enters the tank, larger particles settle to the bottom where they can be removed, and only the top of the slurry, from which the large particles have been removed, can flow through the outlet. In some embodiments, the slurry settling tank may optionally include a sieve, which may be located above the inlet, such as at or near the top of the tank, such that the slurry must flow through the sieve to reach the outlet. When flow of the slurry from the grinder is adequate for the slurry to reach the top of the slurry settling tanks, the slurry may flow through the outlet (or through a plurality of outlets, such as one outlet per centrifuge, depending upon the number of centrifuges and the rate of slurry production by the grinder, for example) and spill over by gravitational force into the outflow pipe or pipes. In some embodiments, the slurry may then flow to a small reservoir, for example, and then to pumps, to make up for intermittent flow, prior to flowing to the centrifuges.

In some embodiments, the water reclamation system includes a single centrifuge which separates the slurry into clean water and solid material. In other embodiments, the water reclamation system includes two centrifuges which operate in parallel. In still other embodiments, the system includes three centrifuges operating in parallel. As such, the output from the slurry storage tank (or from the strainer or strainers or slurry storage tank, if present) can be split to flow to two or three centrifuges. In this way, the flow rate of material through the water reclamation system (the amount of slurry that can be processed per unit time) may be increased by using more than one centrifuge. Each centrifuge divides the slurry into a solid component and cleaned water. The solid component output may be stored in solid material storage tank. The clean water may be stored in a clean water storage tank. Alternatively, the clean water may be further processed and/or released into the environment.

In some embodiments, the water reclamation system includes a plurality of centrifuges, and the operation of each centrifuge may be manually (by an operator) or automatically selected such that either all or less than all of the centrifuges may be employed at the same time during operation of the system. For example, the water reclamation system may include two centrifuges, and either one or both of the centrifuges may be selected to be operational at any time. Alternatively, the system may include three centrifuges, and any one or two or all three of the centrifuges may be selected to operate at one time. For example, in a two centrifuge system, the system may initially operate with one centrifuge functioning as selected by an operator or by the system. During use, if the chosen centrifuge experiences a fault, this centrifuge may stop and the other centrifuge may operate instead. The other centrifuge may take over automatically upon detection of a fault by the system, or at the direction of the operator. Similarly, in a three centrifuge system, two centrifuges may be selected to operate initially, but if a fault is experienced in one of these centrifuges, this centrifuge may cease operating and the third centrifuge may take over operating in its place. Alternatively, the system may allow for an operator to select between the use of all centrifuges at once and the use of less than all of the centrifuges at once, such as one out of two, or one out of three, or two out of three.

A fault that triggers a switch among the centrifuges may be a malfunction in the centrifuge, such as a state of over pressure, over vibration, a problem with spinning, or a hydraulic system fault, for example.

In addition to shutdowns due to faults, a centrifuge may be non-operational for maintenance purposes. The system may be informed of this status of the centrifuge by a signal from the centrifuge so that the system does not initiate operation of the centrifuge.

The centrifuges may be either continuous or batch centrifuges and may be either vertical or horizontal. In some embodiments, the centrifuges are hydraulic. In some embodiments, the centrifuges are vertical and hydraulic. Because the systems are used outdoors, they are exposed to the environment and may become wet. As such, the use of hydraulic centrifuges may be preferred for enhanced safety.

While horizontal or decanter centrifuges are able to generate a higher g-force than vertical centrifuges and therefore clarify water more quickly, they are not preferred because they do not handle large particles as well as vertical centrifuges and require more maintenance. Applicants have discovered that vertical centrifuges are preferable because they are less susceptible to damage during operation, particularly while in motion, such as on a trailer or vehicle.

The solid output of the centrifuges may be substantially dry, such that the majority of the water can be reused. The recovered clean water may be transmitted from the centrifuges to a clean water storage tank. The water in the storage tank is substantially free of solids. For example, the clean water may have only particulates about 5 microns or smaller (no particulates greater than about 5 microns). The solid material separated by the centrifuges is released from the centrifuges. In some embodiments, the centrifuges are oriented in a line with a conveyor such as a conveyor belt running beneath them. Separated solids may be dropped from the centrifuges and onto a conveyor which transports them to the solid material storage tank.

In some embodiments, the system may further process the clean water, such as to decrease the pH to a more neutral value, such as a pH of less than about 10 or less than about 9, such as a pH of between about 6 and about 9. This pH adjustment may be desired, or may be legally required, if the cleaned water is to be released into the environment, such as by pumping the water out onto the ground, such as into a ditch beside the road.

The pH of the cleaned recovered water may be adjusted by adding an acidifying agent to the water, such as hydrochloric acid or aluminum sulfate (which also acts as a flocculent). The acidifying agent can be added to the cleaned water after centrifugation, such as in the cleaned water storage tank, or can be added to the slurry prior to centrifugation. When added prior to centrifugation, some acidifying agents such as aluminum sulfate can act as flocculants during centrifugation. In other embodiments, carbon dioxide, such as pure carbon dioxide or carbon dioxide from engine exhaust, may be used as the acidifying agent such as by bubbling the carbon dioxide through the cleaned water. The cleaned water storage tank may include a sensor for monitoring the pH of the cleaned water, and the system may control the addition of acidifying agent to the tank in order to maintain the pH in a desired range, such as about 6 to about 10 or about 6 to about 9 or about 6 to about 8.

In some embodiments, engine exhaust is used to acidify the cleaned water. The water reclamation system may include a gasoline or diesel burning engine, for example, to provide power to the water reclamation system. The composition of the engine exhaust may vary, depending upon the type of fuel being burned. However, exhaust will typically include a significant amount of carbon dioxide, such as about 5% to about 15% carbon dioxide. As a result, when the exhaust is bubbled through the clean water, the carbon dioxide present in the exhaust dissolves into the water to form carbonic acid, H₂CO₃, thus reducing the pH of the water. Exhaust may be transmitted from the engine exhaust outlet through a system of pipes or hoses or ducts to the exhaust bubbler system within the clean water storage tank. Because the exhaust is already being produced to operate the system, it provides a convenient and constantly regenerating source of acidification.

Embodiments of the water reclamation system which do not include an exhaust bubbler system connect the engine exhaust outlet to an atmospheric outlet such that the exhaust is released into the atmosphere. However, even in systems which include an exhaust bubbler system, it may not be desirable to use the exhaust bubbler system at all times. For example, it may not be necessary to use the exhaust bubbler system while the water is being recirculated for reuse in pavement grinding because alkaline water may be acceptable for this purpose. Rather it may only be necessary or desirable to use the exhaust bubbler system after reuse of the water by the grinding system is complete and prior to disposal of the water such as by release into the environment such as into the ground. In order to provide this flexibility of use, a valve may be included in the water reclamation system to optionally direct exhaust from the engine to an atmospheric outlet or, when the exhaust bubbler system is being used, to the exhaust bubbler system.

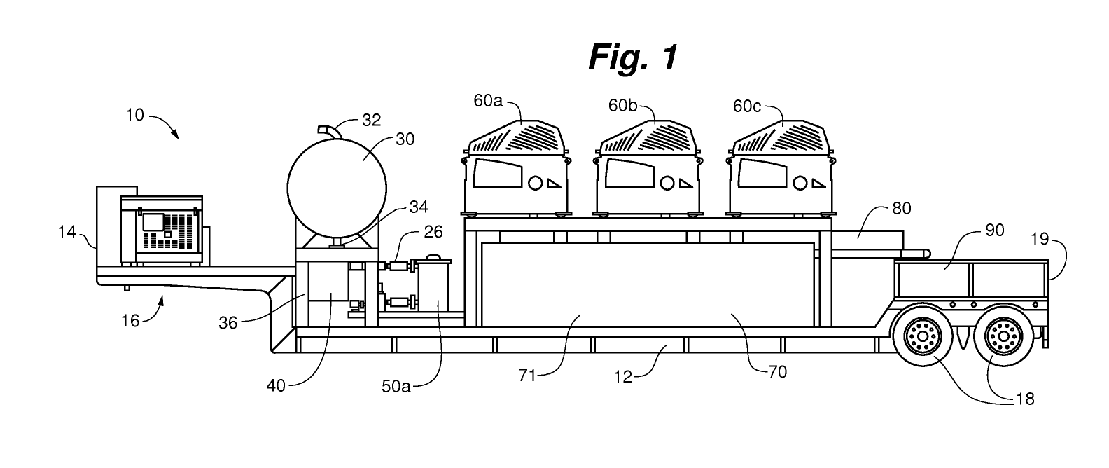

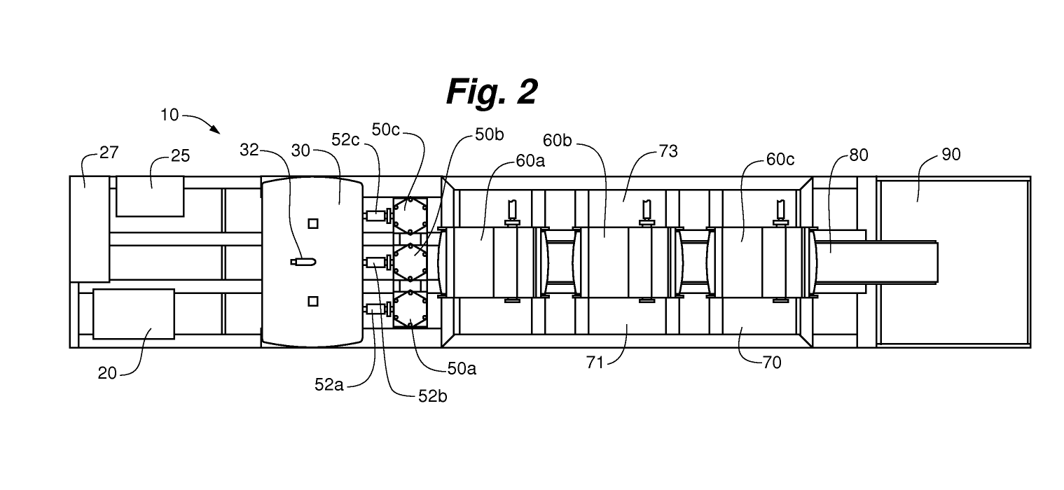

An example of a water recovery system according to embodiments of the invention is shown in FIGS. 1 and 2. In the embodiment shown, the water recovery system 10 is provided on a wheeled trailer, though the system 10 could alternatively be self propelled. The system 10 includes a platform 12 upon which the functional components of the system are supported. The platform 12 is elongated, having a narrower width than length so that the system 10 can be accommodated within a standard traffic lane. For example, the system 10 may be between about 7.5 and about 8.5 feet wide. In order to include all of the necessary components, the system 10 may be between about 15 and about 48 feet long. For example, embodiments including only a single centrifuge 60 may be about 15 to about 20 feet long. Embodiments including two centrifuges 60 may be about 20 to about 30 feet long, and embodiments including three centrifuges 60 may be about 30 to about 48 feet long. While it is desirable for the system 10 to be accommodated within a standard traffic lane, for some applications, such as in non-road applications, a wider platform may be employed.

A first end 14 or front end of the system 10 attaches to a motorized vehicle such as a pavement grinder or a semi cab. As such, the first end 14 may include a king pin or other form of or configuration for attachment and may include a stepped up portion 16 as shown to allow for this connection. The remainder of the platform 12 is horizontal and close to the ground to provide a maximum amount of useful space above the platform 12. A plurality of wheels 18, such as 4 or 8 or 12 wheels 18, are attached to the underside of the platform 12 at the second end 19 or back end of the system 10 to support the back of the system 10, while the front of the system 10 is supported by the connection to the pulling vehicle. If additional support is required, additional wheels 18 may be provided at other appropriate positions along platform 12.

Above the stepped up portion 16 of the platform 12, at the front end 12 of the system 10, is an engine 20, which could operate on diesel, gasoline, natural gas, ethanol, or other fuel source. The engine 20 is connected to a gear box and hydraulic pumps (not shown). Also at the front end 14 of the system 10 are a fuel tank 25 for supplying fuel (such as diesel fuel) to the engine 20 and a hydraulic fluid reservoir 27. The engine 20 powers the hydraulic pumps and is connected through the gears in the gear box. Hydraulic fluid is supplied by the hydraulic pumps through a system of hydraulic tubes, pipes and/or hoses to each of the components which operate hydraulically. These hydraulic components may include one or more of the centrifuges 60, slurry pumps, water pump, and agitators. In some embodiments, a single open loop pump, such as a 100p pump, feeds a valve bank with a plurality of valves. Each valve may control a different component including the water pump, the slurry pumps, the conveyors, the agitators, and the centrifuge gates. In addition, each of the centrifuges may include its own hydraulic pump to operate the motor to spin the centrifuge bowl, and this pump may be hydrostatic rather than open loop. All valves may be operated with 12V DC, and the pumps for the centrifuge bowls may be controlled with a variable DC signal which is proportional to the displacement of the pump with no AC power used in the system. This allows for accurate control over the centrifuge speed, whether or not it is used with a closed loop controller. Also, the hydraulic system that controls the centrifuge may be open loop or closed loop. However, a closed loop system may be preferred since it may be more efficient and may add to the ability of the centrifuge to have dynamic breaking, which can be used to slow the centrifuge in a very controlled manner.

Slurry tank 30 is provided on a central portion of platform 12 at a point behind end 14 spaced away from engine 20. In the embodiment shown, the slurry tank 30 is cylindrical and extends across the width of the platform 12. It includes an input 32 on the top of the tank 30, through which slurry may be pumped into slurry tank 30 after recovery from the roadway by the pavement grinder. On the underside of the slurry tank 30 is an outlet 34 through which the slurry passes when the water reclamation system 10 is operating. The slurry tank 30 is located directly above, and is supported by, a housing 36 which functions as a base for the slurry tank 30 and which can also house the operational controls 40 of the system.

In the embodiment shown in FIG. 1, within the housing 36 are the operational controls 40 of the system 10 including a processor in electrical communication with some or all components of the system 10. On an outer surface of the housing 36, a control panel can be provided as a user interface in electrical communication with the operational controls 40 which allows an operator to interface with the operational controls 40 of the system 10. The operational controls 40 include software to operate and to monitor the system 10 and can continuously monitor safety parameters such as fluid levels in the tanks and centrifuge functioning. The operational controls 40 may be able to shut down the entire system 10, or individual centrifuges 60, when a problem is detected, depending upon the severity of the problem. In addition, the operational controls 40 can monitor the water onboard the pavement grinder with which the water reclamation system 10 is being used to keep the grinder's water tank full so that maximum ballast can be maintained by the grinder.

The control panel on the control housing 36 may include a visual display, a keypad, a touch screen, and/or other types of user interfaces, for example. In the embodiment shown, the system 10 may be controlled using the control panel and/or using a remote controller. The remote controller may be electrically connected to the operational controls or may send and receive signals via infrared, radio (RF) or other form of transmitted energy signal to function as a user interface like the control panel. Using the user interface (control panel or remote control) a user can activate the system 10, select one or more centrifuges 60 for operation, input operation details (such as time and speed), and receive data (such as fluid levels in the slurry tank 30 and the cleaned water tank 70, pH of the cleaned water, fluid level in the grinder water tank, and operational parameters of the engine).

Behind the control housing 36 are three slurry strainers 50a, 50b and 50c, which are located side by side on the platform 12. Pipes connect the slurry tank 30 to the slurry strainer inputs 52a, 52b and 52c. Within the slurry strainers 50a, 50b and 50c large roadway debris is removed from the slurry prior to centrifugation, in order to decrease the wear or damage to the centrifuges. Slurry strainer outputs connect the strainers 50a, 50b and 50c to the centrifuges 60 by pipes and pumps (not shown).

Three centrifuges 60a, 60b and 60c are located in a row from front to back behind the strainers 50a, 50b, and 50c. In other embodiments, the system 10 may include fewer centrifuges 60 or additional centrifuges 60. Strained slurry can flow through pipes into each of the centrifuges 60a, 60b, 60c or, in alternative embodiments, serially from one centrifuge to a subsequent centrifuge. However, operational controls 40 may control the flow such that slurry does not flow to one or more of the centrifuges 60a, 60b, 60c by controlling a valve and/or by turning the centrifuges on and off. After centrifugation, cleaned water flows through water outlets 64 and through pipes into the clean water tank 70. The solid components removed by the centrifuges 60a, 60b, 60c exit through centrifuge solids outlets and drop onto a conveyor 80.

Directly beneath the centrifuges 60a, 60b, 60c is the cleaned water tank housing, which supports the centrifuges, 60a, 60b, 60c and inside which the cleaned water tank 70 fits. By locating the cleaned water tank 70 beneath the centrifuges 60a, 60b and 60c, the cleaned water tank 70 occupies a large space and is therefore able to store a large volume of water.

In the embodiment shown, the cleaned water tank 70 is bifurcated includes a first tank 71 and a second tank 73 in fluid communication with each other. Each of the first tank 71 and the second tank 73 are located side by side and extend along the length of tank 70 beneath each of the centrifuges. The first tank 71 into which water passes directly from the centrifuges 60a, 60b, 60c includes a pH monitor and a pH reduction component such as an exhaust bubbler system 100. The second tank 73, into which water flows from the first tank 71, may include a cooling component to decrease the temperature of the cleaned water. For example, the cooling component may be a cooling coil within the tank which may include a compressed coolant. The cooling component may decrease the temperature of the cleaned water to about 100° F., such as to about 70-100° F., or to less than about 90° F., such as to about 80-90° F., for example. In the embodiment shown, the bifurcation of tank 70 is incomplete such that cleaned water flows freely from the first tank 71 to the second tank 73. Alternatively, the cleaned water tank 70 could be a single tank including a pH monitor, a pH reduction component and a cooling component. However, the applicant has discovered that separating these pH reduction components and the cooling components allows for increased efficiency, as pH reduction was found to be more efficient at higher temperatures. Therefore, in preferred embodiments, the pH reduction component is located upstream prior to and separate from the cooling component.

Conveyor 80 is a conveyor belt which transports the solid component, sometimes referred to as cake, to the solids hopper 90 which is a storage container at the back end 19 of the system 10. In some embodiments, the solids hopper 90 is removable so that it can be removed and replaced by an empty hopper 90 when full. In other embodiments, the solids hopper 90 can pivot up so as to dump the solids into a dump truck or dump trailer, for example. Alternatively, a conventional conveyor or auger can be used to offload the solids from the hopper 90 to a dump truck or dump trailer, for example.

Although not shown, the system 10 may also include walkways and guardrails. The walkways may be located around the periphery of the system 10 to provide access to the system components.

In some embodiments, the system 10 is all hydraulic as described above and under 12V DC operation. In such embodiments, there would be no high voltage, making the system safer to use in a wet environment.

Embodiments of the invention can obtain cleaned water without the use of chemicals. The design of the system 10 allows it to be used without the addition of anti-foaming agents, flocculent, or pH reducers. However, in some embodiments, or when used on certain types of pavement, the use of additional agents may be desirable. For example, certain pavements such as newly surfaced roadways may be coated with a sealant sometimes referred to as cure. Such sealants may be water-based, in which case their presence in cleaned water may be irrelevant or may cause a reduction in water clarity. Other sealants may be oil-based. Such sealants may be removed from the water by an extended centrifugation time and/or by use of an oil skimmer in the cleaned water tank 70. For example, the oil skimmer may be a belt, drum, disk, mop or tube which passes through the cleaned water and removes the oil from the cleaned water. The oil can then be removed from the oil skimmer by wiper blades or a pinch roller, for example. In other embodiments, the oil skimmer may be a floating suction member that removes the oil by suction.

Embodiments of the invention are also highly efficient. For example, a two centrifuge system is able to process the slurry produced by a grinder traveling at 40 feet per minute and having an average pavement removal depth of ¼ inch at the speed at which the slurry is produced. A three centrifuge system is able to process the slurry produced by a grinder traveling at 40 feet per minute and having an average depth of pavement removal of ⅜ inch at the speed at which the slurry is produced. As such, the system 10 is able to travel along with the grinding systems, continuously recycling the water and returning the cleaned water to the grinders, as the grinders move along the pavement. This allows the pavement grinders to continue grinding pavement without stopping work to travel to another location to unload dirty water and reload clean water.

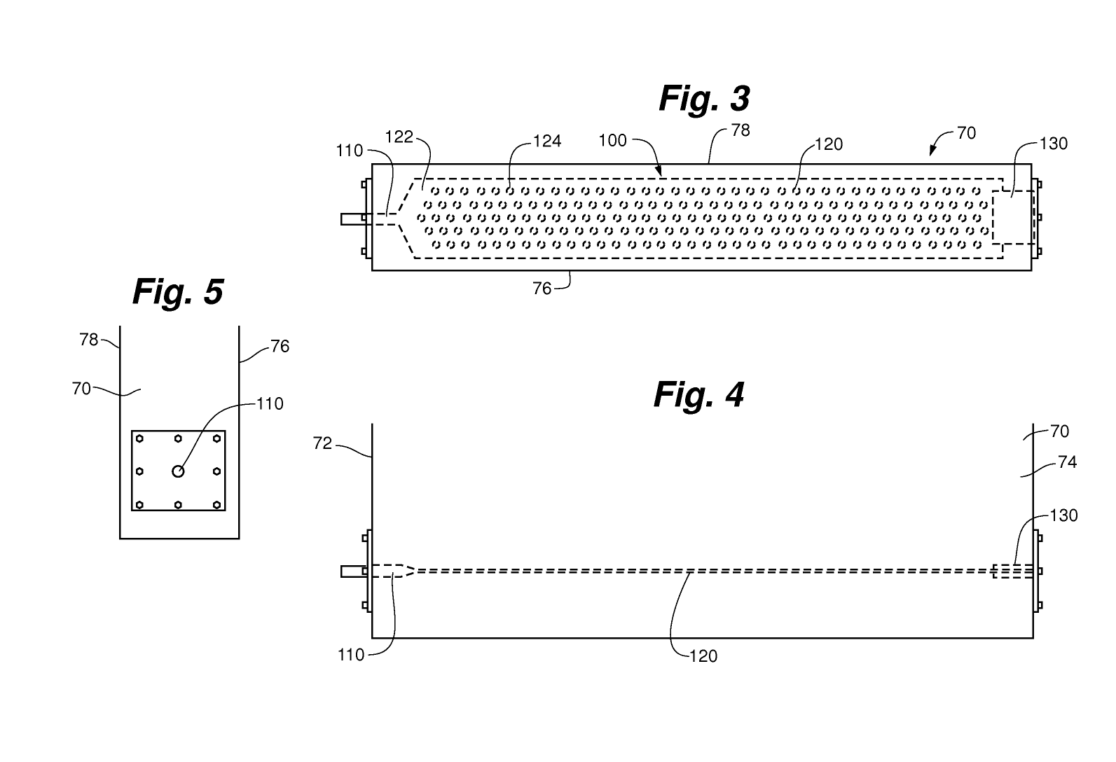

An example of an exhaust bubbler system which may be used in embodiments of the invention is shown in FIGS. 3, 4, and 5. FIG. 3 shows a top view of the exhaust bubbler system 100, while FIGS. 4 and 5 respectively show side and end views of the exhaust bubbler system 100. The exhaust bubbler system 100 is shown submerged within a cleaned water storage tank 70. In other embodiments, the exhaust bubbler system could be located elsewhere in the water reclamation system 10, such as in the slurry tank 30. The system 100 includes an exhaust inlet 110 and a bubbler plate 120 and can also include additional fixation components 130. In the embodiment shown, the bubbler system 100 extends across the tank 70, from the tank front end 72 to the tank back end 74, and is attached to the tank at each of its front and back ends 72, 74 to secure the system 100 within the tank 70.

The plate 120 is elongated and planar, having an upper planar surface 122 with a plurality of small apertures 124, a lower surface, and a gap or passage between the upper and lower surfaces for the flow of exhaust from the inlet 110 to the apertures 122. Exhaust enters the system 100 through the inlet 110, passes into the plate 120 and exits the plate 120 through the apertures 124 as small bubbles. The apertures 124 can therefore be sized to create bubbles of the desired size to obtain the necessary reduction of pH. For example, the apertures may be between about 1/16 inch and ½ inch in diameter, or between about ⅛ inch and ⅜ inch in diameter. In some embodiments, the apertures 124 are located across and generally evenly dispersed over the entire upper surface 122 of the plate 120. Any suitable device known to those skilled in the art to be capable of making a plurality of small bubbles may be used for bubbler system 100. In some embodiments, the exhaust within the plate 120 may be pressurized to reduce back pressure on the engine.

It can further be seen that the plate 120 is shaped to extend across nearly the entire horizontal cross section of the tank 70, from front end 72 to back end 74 and from side wall 76 to side wall 78 of the tank 70, with only a small gap between the plate 120 and the tank walls 72, 74, 76 and 78. In some embodiments, such as those in which the plate 120 is located above the bottom of the tank 70, the gap around the plate provides space for water circulation. In other embodiments, the plate 120 may be located substantially at the bottom of the tank 70 and may or may not include a gap between the plate 120 and tank walls 72, 74, 76 and 78.

It is generally desirable to place the bubbler system 100 deep within the tank, so that the bubbles pass through a sufficient amount of clean water as they float upward from the bubble plate 120 to the top of the cleaned water in the tank 70 and then out into the atmosphere. By passing through a sufficient depth of the water, the exposure or residence time and contact between the bubbles and the water is increased, so that a sufficient pH reduction can occur. However, the presence of an exhaust bubbler system 100 in flow communication with the engine exhaust outlet can create some back pressure on the engine 20. Furthermore, the amount of this back pressure depends upon the depth of placement of the exhaust bubbler system 100 within the tank 70. That is, the deeper the bubbler system 100 is located, the greater the amount of back pressure to which the engine 20 is subjected. It may therefore be preferable to place the bubbler system somewhere above the bottom of the tank 70, but still at a sufficient depth for adequate pH reduction to occur.

In the embodiment shown, it can be seen in FIGS. 4 and 5 that the bubbler plate 120 is located at a distance of approximately one third of the full water depth of the tank above the bottom of the tank 70 (with the surface of the water being near the top of the tank 70 when the tank 70 is full). At this location, it places less back pressure upon the engine 20, while still being at a sufficient depth to expose the water to the bubbles for an amount of time necessary to reduce the pH by the desired amount. In some embodiments, the bubbler plate 120 may be located between approximately the bottom of the tank 70 and a location at approximately one half of the full water depth of the tank 70 above the bottom of the tank 70. For example, the bubbler plate 120 may be located at a depth such that the pressure drop created by the bubbler system 100 is less than about 100 in/H₂O, such as between about 60 in/H₂O and about 80 in/H₂O. In other embodiments, the bubbler plate 120 may be located at a depth such that the pressure drop created by the bubbler system is less than about 50 in/H₂O, such as between about 35 in/H₂O and 45 in/H₂O.

The bubbler system 100 is preferably located at a sufficient depth below the surface of the water such that the exhaust bubbles will reduce the pH by the desired amount, e.g. to reduce the pH to a regulatory required level for release of the water into the environment. For example, in some embodiments, the bubbler system 100 is located at a depth of at least about 100 inches beneath the surface of the cleaned water when the tank 70 is full, such as between about 60 and 80 inches. In other embodiments, the bubbler system 100 is located at a depth of at least about 50 inches beneath the surface of the cleaned water when the tank 70 is full, such as between about 35 and 45 inches.

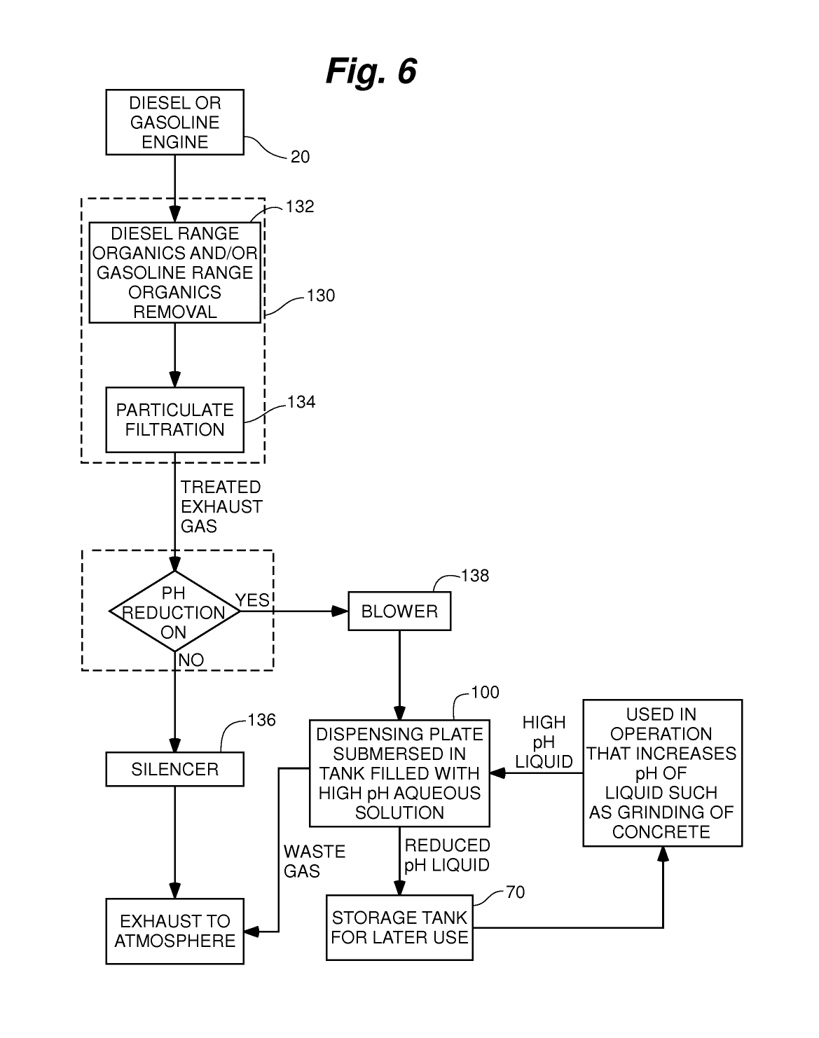

Water reclamation systems 10 which include exhaust bubbler systems 100 may further include a blower 138 (see FIG. 6) located between the exhaust outlet from the engine 20 and bubbler system inlet 110. In some embodiments, the blower 138 is located between the exhaust redirection valve and the bubbler system inlet 110. In such embodiments, the blower 138 may be used to reduce the back pressure placed upon the engine 20 by the bubbler system 100. In embodiments which include a valve for redirecting the exhaust, the blower 138 may only be engaged when exhaust is directed through the bubbler system 100 and may be off when exhaust is vented through the atmospheric outlet.

Because engine exhaust includes additional components besides oxygen and carbon dioxide and these additional components could be transmitted to the water during use of the exhaust bubbler system 100, it may be desirable to remove these additional components from the exhaust prior to passing the exhaust through the exhaust bubbler system 100. Some embodiments therefore include an exhaust cleaning unit for the reduction of these additional exhaust components. The exhaust cleaning unit may be located in close proximity to the engine, such as on top of or along side of the engine, but other locations are also feasible.

The exhaust cleaning unit may remove or reduce the levels one or more components from the exhaust, including contaminants such as carbon monoxide, hydrocarbons and/or particulate matter. Appropriate exhaust cleaning units are commercially available, such as the CleanAIR ASSURE DOCTM system (diesel engine converter system) and the CleanAIR PERMITTM Filter System, both sold by CleanAIR SYSTEMS. The level of contaminant reduction needed will depend upon the type of exhaust cleaning unit used as well as the type of fuel used by the engine 20. In some embodiments, it may be preferable to use low sulfur fuel to minimize the level of contaminants. In some embodiments, carbon monoxide and/or hydrocarbons present in the exhaust are reduced by about 50% or more, such as about 75% or more, or about 90% or more. In some embodiments, particulate matter present in the exhaust is reduced by about 10% or more, such as about 15% or more. In other embodiments, the particulate matter present in the exhaust is reduced by about 50% or more, such as about 70% or more or about 80% or more.

The exhaust cleaning unit includes an exhaust inlet and an exhaust outlet. Between the inlet and the outlet, the exhaust passes through the cleaning components of the unit, and these components may vary depending upon the type of unit used. In some embodiments, the unit includes a catalyst such as an oxidation catalyst which may be located on a filter, such as a wall flow filter within the unit. As the exhaust passes over the wall and/or through apertures in the wall of the cleaning unit, it reacts with the catalyst and the contaminants are removed. The cleaning unit may further include sensors for detecting backpressure and temperature, for example, and a microprocessor which may monitor and log the functioning of the unit, including data such as the time of operation, backpressure, and temperature. This data can be transmitted to the operational controls 40. The cleaning unit may further include a muffler, or a muffler may be provided separately in close proximity to the engine 20, such as on top of the engine 20.

A schematic diagram of an exemplary system to reduce the pH of cleaned water is shown in FIG. 6. Exhaust is produced by a diesel or gas engine 20 and passes to an exhaust cleaning unit 130 which produces treated exhaust having reduced levels of organics and particulates. The exhaust cleaning unit 130 includes an organics removal component 132 and a particulate filtration component 134, which may be two separate components or may be a single component which performs both functions. In some embodiments, the pH reduction may be either activated or not, and the exhaust flow may be redirected accordingly. In other embodiments, the pH reduction is always activated, and no exhaust flow redirection is possible. When the pH reduction system is activated, the treated exhaust the flows through an optional blower 120 and then into the exhaust bubbler system 100 The exhaust is bubbled through the cleaned water having a high pH in order to reduce the pH to a more neutral value, and is then released into the atmosphere. In embodiments in which the exhaust bubbler system 100 can be deactivated, after treatment by the exhaust cleaning unit 130, when the exhaust bubbler system 100 is not activated, the exhaust can pass through a silencer 136 and then vent to the atmosphere. The cleaned and neutralized water can then be discarded, stored for later use in the cleaned water storage tank 70, or used in further pavement grinding operations. If used in further pavement grinding operations, the slurry produced with the recycled water can then be returned to the water reclamation system 10 where the water can again be recovered, the pH reduced, and the water can be reused. In this way, the water can be repeatedly and continuously recycled for use by the pavement grinder.

The cleaned water that is recovered from the slurry may be returned to the pavement grinder. In this way, the pavement grinder is able to continue operating without the need to return to a base location to refill its water tank. As such, the water reclamation system 10 allows for longer uninterrupted operation of the pavement grinders. In addition, the pavement grinders consume less water because the water is continuously recycled, with only small amounts of additional water needing to be added during the pavement grinding process. In this way, the water reclamation system 10 provides a benefit to the environment by conserving and recycling water. Finally, embodiments which adjust the pH of the water provide further environmental benefits by returning the recovered water to a more neutral pH, and thus a pH which has less environmental impact when released.

### Experimental

Water was recovered using a prototype water recycling system as described herein including a diesel engine, a centrifuge, a slurry storage tank, a dry material storage container, and an exhaust bubbler system, but without an exhaust cleaning unit, all mounted on a trailer.

First, pavement was ground using a Cushion Cut PC5000 grinder. The slurry recovered by the pavement grinding system was conveyed to the water recycling system. The water was then processed through the recycling system.

Water was sampled and tested at various points in the process and the results are shown in Table 1 below. Sample 1 was taken prior to any use by the pavement grinding system. Samples 2 and 3 were taken after use in pavement grinding and recovery from two different locations within the slurry tank. Sample 4 was taken from the water after 5 minutes of centrifugation of the slurry. Sample 5 was taken from the water in the cleaned water tank after allowing it to naturally settle for one day without centrifugation or pH reduction. Sample 6 was water that was not centrifuged but was treated by an exhaust bubbler system. The pH was tested according to SM 4500-H+B. The total dissolved solids were measured according to SM2540C and the total dissolved solids were measured according to SM25400D.

TABLE 1

| | | total dissolved | Total suspended |
|---|---|---|---|
| Sample | pH | solids (mg/L) | solids (mg/L) |
| 1 | 8.3 | 310 | 224 |
| 2 | 12.3 | 12500 | 2320 |
| 3 | 12.4 | 19200 | 2900 |
| 4 | 12.3 | 1160 | 1980 |
| 5 | 12.3 | 64.1 | 1860 |
| 6 | 9.0 | 929 | 1000 |

It can be seen in sample 2 that after use in pavement grinding the water became highly basic and acquired a large amount of dissolved and suspended solids. Following partial centrifugation in samples 3 and 4, the total and suspended solids decreased. Sample 5 had reduced solids after settling but was highly basic. Following treatment with the exhaust bubbler system, the pH of the water in Sample 6 decreased to 9.0 in approximately 45 minutes, showing that it was successful at reducing the pH to a level at which it may be disposed of without the need for further pH adjustment. It is unknown why the total suspended solids decreased and the total dissolved solids increased in Sample 6 but it is hypothesized that the carbonic acid created by the exhaust may have reacted with a portion of the suspended solids, causing them to dissolve.

An additional sample of water was obtained after passing through the prototype water recycling system and exhaust treatment system (without an exhaust cleaning unit) as described above with regard to sample 6. This sample was tested for the presence of other contaminants in the water and the results are shown in table 2 below. Total organic carbon (TOC) was measured according to SM 5310C. Sulfur was measured according to EPA 6010. Oil and grease were measured according to EPA 1664 OG. Diesel range organics were measured according to WI MOD DRO.

TABLE 2

| | |
|---|---|
| Total Organic Carbon | 75.9 |
| (mg/L) | |
| Sulfur (mg/L) | 2450 |
| Oil and Grease | Non detected |
| Diesel Range Organics | 11.3 |
| (mg/L) | |

The results in table 2 demonstrate that some amount of contamination may pass from the exhaust produced by diesel fuel and into water when an exhaust bubbler system is used. It may therefore be desirable to use an exhaust cleaning unit to reduce the level of contaminants in the exhaust and/or to use a fuel which produces a cleaner exhaust.

Various examples have been described. These and other examples are within the scope of the following claims.

1. A mobile water recovery system comprising:
a platform having a plurality of wheels;
a slurry storage tank or a slurry settling tank;
a centrifuge in flow communication with the slurry storage tank or slurry settling tank;
a solids storage component;
a cleaned water storage tank in flow communication with the centrifuge.

2. The system of claim 1 wherein the system includes a slurry storage tank, the system further comprising a strainer, wherein the slurry first passes through the strainer and then passes into the centrifuge.

3. The system of claim 1 further comprising an acidifier.

4. The system of claim 1 wherein the acidifier is located within the cleaned water storage tank.

5. The system of claim 4 wherein the acidifier bubbles engine exhaust through the cleaned water.

6. The system of claim 3 wherein the acidifier is configured to dispense a pH adjusting agent into the clean water storage tank.

7. The system of claim 1 wherein the centrifuge is hydraulic.

8. A mobile water recovery system comprising:
a platform having a plurality of wheels;
a slurry storage tank or a slurry settling tank;
a centrifuge in flow communication with the slurry storage tank;
a solids storage component;
a cleaned water storage tank in flow communication with the centrifuge, an engine which produces exhaust;
an exhaust bubbler within the cleaned water storage tank, wherein the exhaust bubbler is configured to receive the exhaust from the engine and release the exhaust through a plurality of apertures as bubbles when the cleaned water storage tank contains cleaned water.

9. The mobile water recovery system of claim 8 wherein the bubbles produced by the exhaust bubbler are sufficient to reduce the pH of the cleaned water to less than about

10. The mobile water recovery system of claim 9 wherein the exhaust bubbler comprises an exhaust inlet and a bubbler plate, wherein the bubbler plate is a horizontally oriented and wherein the plurality of apertures are located on the upper surface of the plate.

11. The mobile water recovery system of claim 8 further comprising a blower located in exhaust flow communication between an exhaust outlet of the engine and the exhaust bubbler.

12. The mobile water recovery system of claim 11 further comprising an exhaust cleaning unit in flow communication between the engine exhaust outlet and the exhaust bubbler, wherein the exhaust cleaning unit reduces the amount of hydrocarbons in the exhaust.

13. A method of recycling water from slurry produced by pavement grinders comprising:
pumping the slurry into a slurry storage tank or slurry settling tank, centrifuging the slurry to separate a solid component from a cleaned water component;
transmitting the cleaned water component from the centrifuge to a cleaned water tank; and
transmitting the solid component to a solids storage component;
wherein each of the slurry storage tank, the centrifuge, the cleaned water tank, and the solids storage component are components of a mobile water reclamation system.

14. The method of claim 13 further comprising towing the mobile reclamation system behind a pavement grinder.

15. The method of claim 13 further comprising reducing the pH of the cleaned water within the cleaned water tank.

16. The method of claim 15 wherein the mobile water reclamation system further comprises an engine which produces exhaust, wherein reducing the pH of the cleaned water comprises bubbling the exhaust through the cleaned water.

17. The method of claim 16 further comprising reducing an amount of hydrocarbons present in the exhaust prior to bubbling the exhaust through the cleaned water.

18. A system for acidifying a fluid comprising:
an engine which produces exhaust including carbon dioxide;
a fluid tank;
an exhaust bubbler having a plurality of apertures and located within the fluid tank;
wherein exhaust produced by the engine flows to the exhaust bubbler and through the apertures.

19. The system of claim 18 further comprising an exhaust treatment unit, wherein exhaust flows through the exhaust treatment unit prior to flowing through the bubbler, and wherein the exhaust treatment unit is designed to remove organics and particulates from the exhaust.

20. The system of claim 19 further comprising a blower, wherein the exhaust flows through the blower prior to flowing through the exhaust bubbler.

21. A centrifugation system comprising:
a housing having an inlet and a first outlet;
a rotatable bowl within the housing in flow communication with the inlet and the outlet, wherein the rotatable bowl rotates around a central axis and wherein the central axis is vertical;
a hydraulic pump which powers rotation of the rotatable bowl, wherein the hydraulic pump is a hydrostatic pump.

22. The centrifugation system of claim 22 wherein the hydraulic pump is controlled by a variable DC signal.
